(19) United States
(12) Patent Application Publication
(10) Pub. No.: US 2009/0315729 A1
(43) Pub. Date: Dec. 24, 2009

(54) Method and System for Preventing Misfueling

(76) Inventor: Scott Inhoffer, Lehighton, PA (US)

Correspondence Address: AXINN, VELTROP & HARKRIDER LLP;Attn. Michael A. Davitz, 114 West 47th Street, New York, NY, 10036, US

(21) Appl. No.: 12/135,947

(22) Filed: Jun. 9, 2008

Related U.S. Application Data
(60) Provisional application No. 60/942,738, filed on Jun. 8, 2007.

(51) Int. Cl. G08B 17/10

(52) U.S. Cl. 340/632

(57) ABSTRACT

The methods and system of the present invention provide for a means of preventing the introduction of incorrect fuel type into an engine. Data is transmitted wirelessly from a fuel storage apparatus to at least one receiver. In part, the selected data comprises the type of fuel that is required to be introduced into the fuel storage apparatus. Data is also transmitted wirelessly from a fuel dispensing apparatus to the receiver. In this case, the data comprises, in part, the type of fuel present in the fuel dispensing apparatus. The receiver determines whether the type of fuel required to be introduced into the fuel storage apparatus corresponds to the type of fuel present in the fuel dispensing apparatus. If the two types of fuel correspond, i.e., match, fuel is dispensed from the fuel dispensing apparatus into the fuel storage apparatus. If the two types of fuel do not match, the fuel dispensing apparatus is not activated. The receiving apparatus may also provide an indication that the fuel from the fuel dispensing apparatus does not match the type required to be introduced into the fuel storage apparatus. In another embodiment, if the two types of fuel do not match, a cut-off system is activated that stops dispensing of the fuel during the fueling process.

This application claims the benefit of U.S. Provisional Application No. 60/942,738, filed Jun. 8, 2007.

### FIELD OF THE INVENTION

The present invention relates to a method and system for determining the type of fuel that is required to be dispensed into a fuel storage apparatus and provides for a means of either warning that the incorrect fuel type will be introduced and/or cutting-off the fueling before the incorrect fuel type has been introduced into a fuel storage apparatus.

### BACKGROUND OF THE INVENTION

A major problem with fueling of vehicles, especially airplanes, is the introduction of the incorrect type of fuel into the engine. Introducing the wrong type of fuel into an aircraft can cause failure of the engine during flight resulting in a crash or substantial damage to the engine. The British Petroleum describes misfueling of aircrafts as one of the biggest risks the aviation industry faces (Misfuelling. Air BP [online], [retrieved on Jun. 10, 2008]. Retrieved from the Internet <URL: http://www.bp.com/sectiongenericarticle.do?categoryId=4503801&contentId=57961>). For example, a review of the National Transportation Safety Board (“NTSB”) databases for accidents related to fueling mistakes indicates that when the incorrect type of fuel had been introduced into the airplane it crashed shortly after take-off (see, NTSB Report FTW86FA079). In an attempt to address this serious problem, the airline industry has painted fueling nozzles different colors and established different standards for the diameter of both the fueling nozzle as well as the aperture on fuel tanks.

For example, Avgas fuelling nozzles for over-wing dispensing are painted red. The nozzle of an Avgas fueler is limited to a maximum diameter of 40 mm (internationally) and 49 mm in the United States. In contrast, nozzles for Jet A-1 fuel are larger than 60 mm.

The development of fuel port adaptors that allow the use of jet fuel while preventing the introduction of Avgas has been considered (see, for example, U.S. Patent Application Publication No. 2007/0000571 A1).

However, the use of different nozzle types has not solved the problem and the incorrect fuel type continues to be introduced into a vehicle such as an aircraft. Because of the serious consequences of introducing the incorrect fuel type into an aircraft which include death and major damage to the aircraft, there remains a pressing need to develop methods and systems for preventing the introduction of the incorrect fuel type to engines, especially ones that power aircraft.

### SUMMARY OF THE INVENTION

The present invention provides for a method and system for preventing the introduction of incorrect fuel type into an engine. Selected data from an identification device (first identification device) is transmitted by wireless means (first signal) from a fuel storage apparatus to at least one receiver. The receiver may be a Radio Frequency Interrogator, which may be associated with a server. The selected data comprises the type of fuel that is required by the fuel storage apparatus. Selected data from another identification device (second identification device) is also transmitted by wireless means (second signal) from a fuel dispensing apparatus to the receiver. The selected data comprises the type of fuel present in the fuel dispensing apparatus. The type of fuel required to be introduced into the fuel storage apparatus is then programmatically compared in the receiver with the type of fuel present in the fuel dispensing apparatus. If the type of fuel present in the fuel dispensing apparatus matches the type required to be introduced into the fuel storage apparatus, the fuel in the fuel dispensing apparatus is dispensed. If the fuel in the fuel dispensing apparatus does not match the type required to be introduced into the fuel storage apparatus, a warning indicator may be activated. The means of warning may comprise a flashing light. The flashing light may be red in color.

In one embodiment, the fuel in the fuel dispensing apparatus is prevented from being dispensed, if the fuel from the fuel dispensing apparatus does not match the type required to be introduced into the fuel storage apparatus. In another embodiment, the fuel dispensing apparatus may be deactivated or shut-off during the fueling process if the fuel contained in the fuel dispensing apparatus does not match the type required to be introduced into the fuel storage apparatus.

The wireless means may comprise radio frequency, for example, very short-range radio frequency such as Bluetooth. Alternatively, the wireless means may comprise infrared or magnetic energy.

The selected data representing the type of fuel in the fuel storage apparatus and the fuel dispensing apparatus may be stored in a plurality of uniquely associated radio frequency identification (“RFID”) tags. RFID tags may be associated with the fuel dispensing apparatus, fueling nozzles, fuel port adaptors, or the fuel storage apparatus. The receiver may comprise a RFID interrogator which may be connected to a server. The RFID interrogator may be associated with the fuel dispensing apparatus, or the fuel storage apparatus. The RFID interrogator may also be a stand-alone system.

The RFID interrogator may be connected to a plurality of servers. The RFID interrogator may display the type of fuel required to be introduced into the fuel storage apparatus. The RFID interrogator may also display whether an additive such as an anti-icing additive is required. The server may be used to determine the correct mixture ratio for the type of fuel required to be introduced into the fuel storage apparatus.

The methods and systems of the present invention may be used to control the introduction of fuel into any type of engine, including, jet engines, propeller engines, automobile engines, boat engines and the like. In a preferred embodiment, the type of engine is a jet or propeller type engine such as turbofan, rocket, ram jet, turboprop or scram jet.

### BRIEF DESCRIPTION OF THE FIGURES

FIG. 1—Block Diagram Illustrating Fueling System

FIG. 2—Flow Chart for Fuel Type Detection and Authorization

### DETAILED DESCRIPTION OF THE INVENTION

The present invention provides for methods and systems of preventing the introduction of incorrect fuel type into an engine. Data from an identification device (first identification device) is transmitted wirelessly (first signal) from a fuel storage apparatus to at least one receiver. In part, the selected data comprises the type of fuel that is required to be introduced into the fuel storage apparatus. Data from another identification device (second identification device) is also transmitted wirelessly (second signal) from a fuel dispensing apparatus to a receiver. In this case, the data comprises, in part, the type of fuel present in the fuel dispensing apparatus. The receiving apparatus is programmed to determine whether the type of fuel required to be introduced into the fuel storage apparatus corresponds to the type of fuel present in the fuel dispensing apparatus. If the two types of fuel correspond, i.e., match, fuel is dispensed from the fuel dispensing apparatus into the fuel storage apparatus. If the two types of fuel do not match, a warning system is activated indicating that the fuel from the fuel dispensing apparatus does not match the type required to be introduced into the fuel storage apparatus. In one embodiment, a cut-off system is activated that prevents dispensing of the fuel. In another embodiment, the system may comprise a flashing light which may be red in color indicating to the person dispensing the fuel that the type of fuel contained in the fuel dispensing apparatus and the type required by the fuel storage apparatus are not the same.

### Communications System

The disclosed method comprises a wireless means of communication. In one embodiment, it may be a very short range radio frequency (RF). For example, the wireless frequency may be 2.4 GHz as per BLUETOOTH standards, and/or having a 20 to 100 foot range. The RF transmitter may operate in common frequencies which do not necessarily require a license from the regulating government authorities, e.g., the Federal Communications Commission (FCC) in the United States. Alternatively, the wireless communication can be accomplished with infrared transmitters and receivers, magnetic energy and the like.

The systems and methods of the present invention may use a Radio Frequency Identification (“RFID”) tag for transmitting or receiving any data by radio frequency. In one embodiment, at least one of the RFID tags is active RFID. The term “active” refers to the fact that a battery or other power source is incorporated into the RFID tag. Active RFID tags are wireless transponders that can automatically track, identify, monitor and locate an item (see, GRIEBENOW. Introducing Active RFID. RFID Switchboard [online], [retrieved on Jun. 10, 2008]. Retrieved from the Internet <URL: http://www.rfidsb.com/index.php?page=rfidsb&c_ID=156>). The active RFID tags may be “woken-up” when they are in the vicinity of a fuel dispensing location, i.e., through the use of proximity detectors which may be incorporated into the RFID (see, U.S. Patent Publication No. 20060192002; Long Range Proximity Readers, RF Logics [online], [retrieved on Jun. 10, 2008], retrieved from the Internet <URL: http://www.rflogicsinc.com/Long_Range_Prox/index htm>; and U.S. Pat. No. 5,956,259). The active RFID tag may also incorporate sensors to detect changes in pressure, humidity as well as the presence of hazardous chemicals.

In another embodiment, at least one of the RFID tags may be passive. A passive tag is an RFID tag that does not contain a battery; the power is supplied by the RFID interrogator. When radio waves from the reader are encountered by a passive RFID tag, the coiled antenna within the tag forms a magnetic field. The tag draws power from it, energizing the circuits in the tag. The tag then sends the information encoded in the tag's memory. An RFID tag maybe capable of relaying the type and amount of fuel located in the fuel tank, which can be used as a backup to current fuel storage tank measuring devices. RFID tags may be purchased commercially from a variety of different sources (for example, Omron Corp., One Commerce Drive Schaumburg, Ill. 60173).

The methods and systems of the present invention incorporate an RFID reader or interrogator which can act as the receiver. An RFID interrogator is an electronic device that generates and receives an interrogation signal such as a radio signal. The radio signals are radiated or received by a plurality of antennas that are attached to the RFID interrogator. RFID Interrogators are capable of (i) reading and writing data to RFID tags (active or passive); (ii) operating on either a single or on multiple frequencies; (iii) performing anticollision processing; (iv) reading bar code; or (v) of other Automatic Data Collection (ADC) capabilities (see, for example, U.S. Pat. No. 6,075,973). RFID interrogators may be purchased commercially from a variety of different sources (for example, Omron Corp., One Commerce Drive Schaumburg, Ill. 60173). The RFID interrogator may be connected to a server or to a multiplicity of servers, either via a cable connection or by wireless means. The RFID interrogator can issue addressed commands, i.e., those that affect only one RFID tags as well as non-addressed commands, i.e., those that are obeyed by all RFID tags in range.

In yet another embodiment, sensing units may be utilized. The sensing units may be used together, i.e., integrated or connected, or may be used separately (for example, see, R. Clauberg. RFID and Sensor Networks, RFID Workshop, University of ST. Gallen, Switerzerland, Sep. 27, 2004 for a discussion of integration of sensor networks with RFID). The sensing unit may communicate data directly with the RFID interrogator (i.e., via infrared or radio frequency) or the sensing unit may communicate first with a processor which then converts the data into a form readable by the RFID interrogator. Sensing units may include those that (i) detect changes in pressure; (ii) detect changes in humidity; (iii) detect fuel types based on a predetermined physical or chemical characteristic (see, U.S. Pat. No. 6,871,677); and/or (iv) proximity of other aircraft. For example, a gas detecting system could be used for classifying the type of liquid fuel in a container or tank (see, U.S. Pat. No. 5,654,497). Alternatively, a particle detection system such as that produced by Parker Hannifin Ltd. (United Kingdom) could be used. There, the system termed, the ACM 20, detects particle size and can be linked directly to a central processing unit (Fast, Easy and Accurate Aviation Fuel Contamination Monitoring from Parker Hannifin. Airport International [online], [retrieved on Jun. 10, 2008]. Retrieved from the Internet <URL: http://www.airport-int.com/categories/airport-fuel-contamination/fast-easy-and-accurate-aviation-fuel-contamination-monitoring-from-parker-annifin.asp>).

Of particular significance, the present invention may incorporate a sensor capable of determining and continuously monitoring the composition of fuel contained in the fuel dispensing apparatus or fuel storage apparatus. This sensor/monitor may provide real-time feedback indicating whether foreign objects or chemicals have been mixed with the fuel at any point in the fueling process (i.e., whether the fuel has been tampered with). Tampering of fuel is a potential method by which persons adverse to the United States may attempt to cause damage and destruction to the United States citizens lives and property. This particular embodiment of the present invention, therefore, may result in a significant improvement to homeland security. These sensors could provide real-time information which could be used to actuate a cut-off in the system in the event a contamination would be detected, i.e., the type of fuel required and the type of fuel stored would not match.

In one embodiment of the present invention, the RFID interrogator is associated with the fuel dispensing apparatus. In another embodiment, the RFID interrogator is associated with the fuel storage apparatus. The RFID interrogator may also be a stand-alone system. The RFID interrogator may display the type of fuel required to be introduced into the fuel storage apparatus. The RFID interrogator server may also display whether an additive such as an anti-icing additive is required.

### Fuel Types

Aviation turbine fuels are used for powering jet and turbo-prop engine aircraft. There are two main grades of turbine fuel in use in civil commercial aviation: Jet A-1 and Jet A, both are kerosene type fuels. A third grade of jet fuel is Jet B which is a wide cut kerosene (a blend of gasoline and kerosene); however, it is usually used only in very cold climates. The military equivalent of Jet B is JP-4 which contains a corrosion inhibitor as well as anti-icing additives. Other types of military jet fuels are JP-5 and JP-8.

A number of additives can be added to jet fuel. Usually, these additives are added at concentrations of a few parts per million. Additives in common use include the following: (i) anti-knock additives which reduce the tendency of gasoline to explode; (ii) anti-oxidants which prevent the formation of gum deposits on the fuel system components that are caused by oxidation of the fuel in storage; (iii) static dissipater additives which reduce the hazardous effects of static electricity generated by movement of fuel through modern high flow-rate fuel transfer systems; (iv) corrosion inhibitors which protect ferrous metals in fuel handling systems, such as pipelines and fuel storage tanks, from corrosion; (v) fuel system icing inhibitors (anti-icing additives) that reduce the freezing point of water precipitated from jet fuels due to cooling at high altitudes; (vi) metal de-activators which suppress the catalytic effect that some metals, particularly copper, have on fuel oxidation; (vii) biocide additives that are sometimes used to inhibit microbiological growths in jet fuel, often by direct addition to aircraft tanks; (viii) thermal stability improver additives, such as those sometimes used in military JP-8 fuel to produce a grade referred to as JP-8+100, to inhibit deposit formation in the high temperature areas of the aircraft fuel system; and (ix) power-boosting fluids used in order to increase take-off power.

Avgas is a gasoline fuel that is used for reciprocating piston engine aircraft. Avgas grades are defined by their octane rating. Two ratings are applied to aviation gasolines, lean mixture and the rich mixture ratings (see, Aviation Fuels Technical Review, Chevron Products Corporation, [online], [retrieved on Jun. 10, 2008]. Retrieved from the Internet <URL: http://www.chevron.com/products/ourfuels/prodserv/fuels/documents/aviation_fuels.pdf). Currently the two major grades in use internationally are Avgas 100LL and Avgas 100; Avgas 100LL is colored blue, while Avgas 100 is colored green.

The methods and systems of the present invention may be used with any fuel type, including, diesel, rocket fuel, gasoline, ethanol, and the like.

### Engine Types

The types of engines encompassed by the present invention include, jet engines, propeller engines, automobile engines, boat engines, and the like. In a preferred embodiment, the type of engine is a jet or propeller type engine such as turbine, including turbofan and turboprop; rocket; ram jet; or scram jet (Jet Engine. Wikipedia [online], [retrieved on Jun. 10, 2008]. Retrieved from the Internet <URL: http://en.wikipedia.org/wiki/Jet_engine>). Examples of turbine engines include the JT15D produced by Pratt Whitney (see, JT15D. Pratt Whitney [online], [retrieved on Jul. 2, 2008]. Retrieved from the Internet <URL: http://www.pwc.ca/en/3_{—}0/3_{—}0_{—}1/3_{—}0_{—}1_{—}1_{—}1.asp>). Other examples of turbine engines can be found at GE Aviation products ([online], [retrieved on Jul. 2, 2008]. Retrieved from the Internet <URL: http://www.geae.com/engines/index.html>) and Rolls-Royce products ([online], [retrieved on Jul. 2, 2008]. Retrieved from the Internet <URL:http://www.rolls-royce.com/civil_aerospace/products/default.jsp>). Examples of gasoline engines that utilize mixtures such as 100 LL, 100, 80/90 or automotive gas, include, piston engines (see, for example, Teledyne Continental Motors [online], [retrieved on Jun. 10, 2008]. Retrieved from the Internet <URL:http://www.tcmlink.com/fiDDefault.aspx>). Diesel engines are also being produced (see, for example, DeltaHawk diesel engines [online], [retrieved on Jun. 10, 2008]. Retrieved from the Internet <URL: www.deltahawkengines.com> and Centurion aircraft engines [online], [retrieved on Jun. 10, 2008]. Retrieved from the Internet <URL: www.centurion-engines.com>).

### Fuel Storage Apparatus in an Airplane

In an airplane, fuel may be stored in different types of storage apparatus, including integral, rigid removable, and bladder fuel tanks. Integral tanks are incorporated into the aircraft structure such as the wing or tail. Integral tanks generally cannot be removed for service or inspection. Inspection panels are provided to allow internal inspection, repair and servicing of the tank. In one embodiment an active RFID tag used to communicate the type of required fuel is located on the inspection panel. Rigid removable tanks are installed in a compartment designed to accommodate the tank. Rigid removable tanks may be removed for inspection, replacement or repair. In one embodiment an active RFID tag used to communicate the type of required fuel is located on the removable tank. Bladder tanks are reinforced rubber bags installed in the aircraft. In one embodiment an active RFID tag used to communicate the type of required fuel is located on the bladder.

Aircraft may also store fuel in external tanks attached to the fuselage or the wing. One type of external fuel tank is a drop tank, which is an expendable and often jettisonable tank carried by aircraft for long-range flights. It is designed to be discarded when empty. Another type of external fuel tank is a conformal fuel tank or CFT. A CFT is fitted closely to the profile of an aircraft and can only be removed on the ground. In one embodiment an RFID tag is located on the external fuel tank.

### Fuel Dispensing Apparatus

Fuel may be dispensed from any conventional fuel dispensing apparatus. Fuel may be stored in a variety of different storage vessels (fuel tanks), including, for example, a stationary stainless steel tank (see, e.g., Fuel Proof aviation products [online], [retrieved on Jul. 2, 2008]. Retrieved from the Internet <URL: http://www.fuelproof.co.uk/taviation/>) or a fuel truck (see, e.g., NAP products [online], [retrieved on Jun. 10, 2008]. Retrieved from the Internet <URL: http://www.neacorp.con/details.aspx?ID=45>). The fuel dispensing systems of the present invention encompass use of a hydrant system (jet fuel), refueler truck (avgas or jet fuel), or a dispenser (avgas or jet fuel). In the hydrant system a network of underground pipes connects the storage tanks to each gate. A hydrant unit, which comprises either a truck or cart, is typically equipped with filtration and volume metering equipment, is used to fuel an aircraft. Hose connections are made between the hydrant and the unit, and the unit and the aircraft. However, potentially, any type of fuel storage apparatus may be used with the methods and systems of the present invention. The fuel dispensing apparatus may incorporate pumps and filters. In addition, the fuel dispensing apparatus may incorporate, a filter water separator, a filter monitor, flow meter, a hose coupled to a nozzle, an earthling system, a spill box, a sample glass, instrumentation, a starter panel and a pump unit. The fuel dispensing apparatus is connected to an aircraft nozzle for dispensing the fuel into the fuel storage apparatus. For example, the nozzle may be an Avgas fueling nozzle produced by OPW (see, OPW products [online], [retrieved on Jun. 10, 2008]. Retrieved from the Internet <URL: https://www.opw-fc.com/product_detail.aspx?pid=180>). However, any fuel-dispensing nozzle may be incorporated and used in the methods and systems of the present invention (see, BASCO products [online] for a description of various fueling, hose and pump systems that are commercially available [retrieved on Jun. 10, 2008]. Retrieved from the Internet <URL: http://www.bascousa.com/store/>).

### System Description

The following examples illustrate various aspects of the present invention. They are not to be construed to limit the claims in any manner.

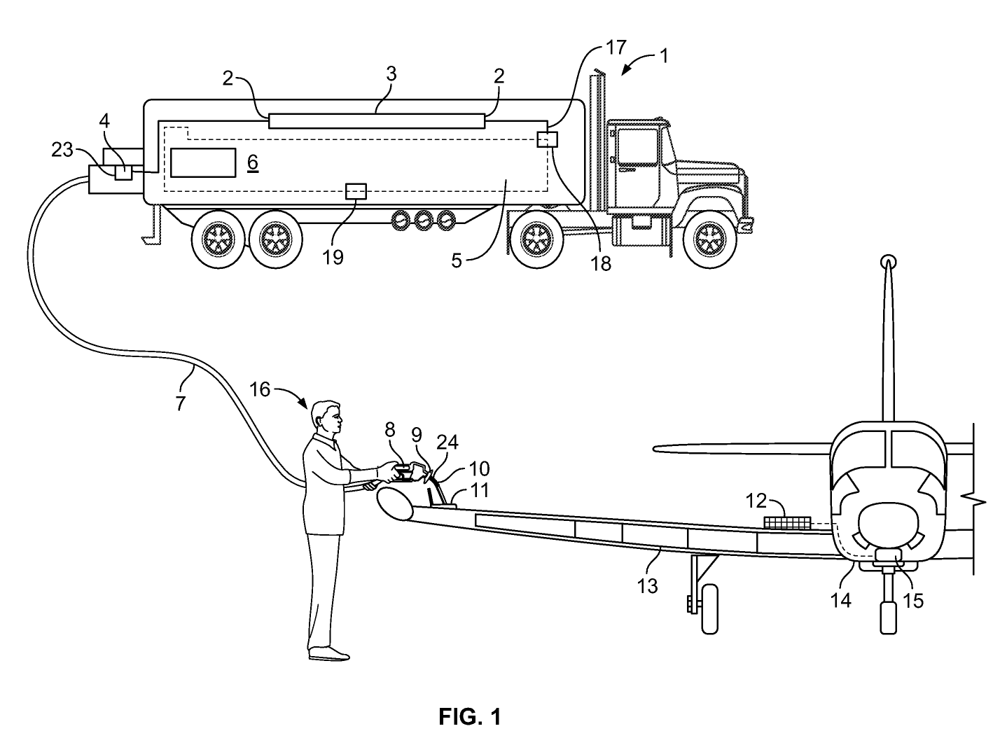

FIG. 1 shows a system embodying the invention. The invention provides for means and a system of delivering fuel to a plane from an aboveground storage system such as a fuel truck 1. The fuel truck 1 incorporates a fuel dispensing apparatus 5 and a fuel pump 4. As used herein, a fuel dispensing apparatus may be a fuel tank. Integrated into the fuel truck 1 is an RFID interrogator 3 coupled to a plurality of RFID antennae 2. Data representing the type of fuel contained in the fuel dispensing apparatus 5 is contained in RFID interrogator 3. In another embodiment, data representing the type of fuel contained in the fuel dispensing apparatus 5 is contained in RFID tag 19 and wirelessly transmitted to the RFID interrogator 3. The fuel truck 1 may incorporate a liquid crystal display (“LCD”) screen 6 which can display the amount of fuel, e.g., in liters or gallons, that has been dispensed by the fuel truck 1. The fuel pump 4 is linked to the RFID interrogator 3. The fuel pump 4 is connected to a flexible hose 7 which in turn is connected to a fuel nozzle 10. The fuel nozzle 10 may incorporate an RFID tag 9 as well as an LCD screen 8. When fuel is pumped from the fuel truck 1, it is dispensed through the fuel nozzle 10 into a fuel port 11 on the wing of the airplane 14. The fuel storage 13 of the airplane may be found in the wing or alternatively, may be external, e.g., a fuel pod. In close proximity to the fuel port 11, at least one RFID tag 12 is affixed to the wing. Data representing the type of fuel required by the airplane is contained in RFID tag 12. The RFID tag 12 may be linked to an internal power source 15 on the airplane 14. The RFID tag 9 may incorporate a proximity detector which determines whether the fuel nozzle 10 has been introduced into the fuel port 11. The RFID tag 12 may also incorporate an independent power source such as a battery or solar-powered screen.

In this example, the RFID tag 9 transmits to the RFID interrogator 3 data indicating that the aircraft is ready to be fueled. In another embodiment, the RFID tag 9 may also contain data representing the type of fuel contained in the fuel dispensing apparatus 5 which it wirelessly transmits to the RFID interrogator 3. The RFID interrogator 3 transmits a request to the RFID tag 12 requesting that it be provided information concerning the type of fuel required to be introduced into the fuel storage 13. The RFID tag 12 transmits this information to the RFID Interrogator 3. The RFID tag 12 may also transmit to the RFID Interrogator 3 other information such as the airplane identification code, the engine type, the number of engine hours, etc. Information may be transmitted in any order or desired manner; however, transmission occurs only when the airplane is in proximity with the fuel truck 1 or other fuel dispensing apparatus.

The RFID interrogator 3 compares the information received from the RFID tag 12 with the information concerning the type of fuel contained in the fuel dispensing apparatus 5. If the comparison indicates that the fuel required by the airplane is the same as that contained in fuel dispensing apparatus 5, the RFID interrogator 3 activates the fuel pump 4 and fuel is dispensed from the fuel dispensing apparatus 5 into the fuel storage 13. If the comparison indicates that the fuel contained in the fuel dispensing apparatus 5 is not the type required by the airplane, the fuel pump 4 is not activated. In an alternative embodiment, the RFID interrogator 3 activates a flashing red light 23 located at the fuel pump 4 or a flashing red light 24 located at the fuel nozzle 10 to indicate to a fueling person 16 that there is a discrepancy. The RFID interrogator may also transmit information indicating a discrepancy to the RFID tag 9 for display on the LCD screen 8.

In another example, the RFID interrogator 3, containing the data representing the type of fuel contained in the fuel dispensing apparatus 5, may be connected to the fuel dispensing apparatus 5 via a connector 17. A fuel type sensing unit 18 may be attached to the connector 17. Sensing units can comprise any type of sensors which can be used, for example, to identify types of fuel (see, U.S. Pat. No. 6,871,677). In one embodiment the sensing unit 18 communicates directly with the RFID interrogator 3. In another embodiment the sensing unit 18 communicates with a microprocessor which then converts the data from the sensor into a form readable by the RFID interrogator 3.

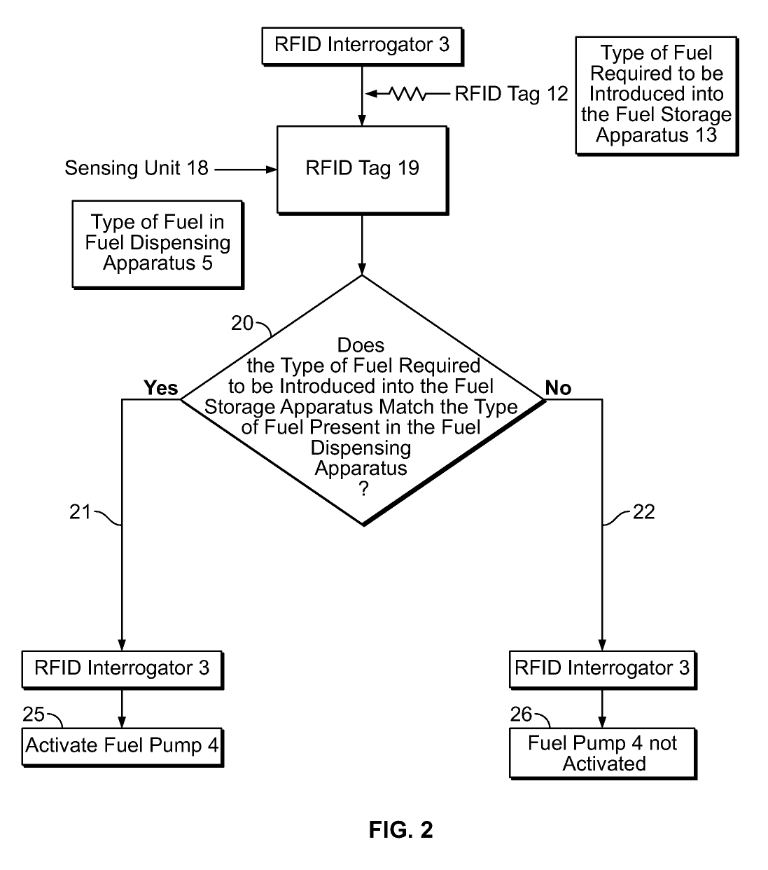

FIG. 2 presents a flow chart for the fuel type detection and authorization for fueling. The RFID tag 12 sends information to the RFID interrogator 3 indicating the type of fuel required to be introduced into the fuel storage 13. The fuel type sensing unit 18 identifies the type of fuel present in the fuel dispensing apparatus 5 and sends the information to the RFID tag 19, which then transmits the data to the RFID interrogator 3. The RFID interrogator 3 queries whether the type of fuel required to be introduced into the fuel storage apparatus 13 matches the type of fuel present in the fuel dispensing apparatus 5. If the answer to query is “yes”, 21, the RFID Interrogator 3 activates the fuel pump 4 (step 25). The fueling person 16, now inserts the fuel nozzle 10 into the fuel port 11 and fuel is dispensed into the fuel storage 13.

If the answer to query is “no”, 22, the RFID interrogator 3 does not activate the fuel pump 4 (step 26). In an alternative embodiment, if the answer to the query is “no”, 22, the RFID interrogator 3 may activate a flashing red light which may be positioned either at the fuel pump 23 or at the fuel nozzle 24. Flashing of the red light would indicate to the fueling person 16 that there is a discrepancy between the fuel required by the airplane and the fuel contained in the fuel dispensing apparatus 5. In another alternative embodiment, if the answer to the query is “no”, 22, the RFID interrogator 3 deactivates the fuel pump 4 during the fueling process, stopping the flow of fuel from the fuel dispensing apparatus 5 to the fuel storage 13.

Numerous references, including patents and various publications, are cited and discussed in the description of this invention. The citation and discussion of such references is provided merely to clarify the description of the present invention and is not an admission that any reference is prior art to the invention described herein. All references cited and discussed in this specification are incorporated herein by reference in their entirety.

The embodiments illustrated and discussed in this specification are intended only to teach those skilled in the art the best way known to the inventors to make and use the invention. Nothing in this specification should be considered as limiting the scope of the present invention. Modifications and variation of the above-described embodiments of the invention are possible without departing from the invention, as appreciated by those skilled in the art in light of the above teachings. It is therefore understood that, within the scope of the claims and their equivalents, the invention may be practiced otherwise than as specifically described.

What is claimed is:

1. A method of preventing introduction of an incorrect fuel type into an engine, comprising the steps of:
(a) wirelessly transmitting a first signal to at least one receiver, said first signal corresponding to a first fuel type designated for storage in a fuel storage apparatus;
(b) wirelessly transmitting a second signal to at least one receiver, said second signal corresponding to a second fuel type contained within a fuel dispensing apparatus, wherein said first and second fuel types are the same or different;
(c) determining whether said first and second fuel types are the same or different based on said first and second signals.

2. The method of claim 1 further comprising the step of providing an indication to a user when said first fuel type is different from said second type.

3. The method of claim 1 further comprising the step of activating said fuel dispensing apparatus when said first fuel type is the same as said second type.

4. The method of claim 1 wherein the engine is selected from the group consisting of jet engines, propeller engines, automobile engines and boat engines.

5. The method of claim 4 wherein the engine is a jet engine.

6. The method of claim 4 wherein the engine is a propeller engine.

7. The method of claim 1 wherein the type of fuel contained in the fuel dispensing apparatus is Avgas.

8. The method of claim 1 wherein the type of fuel contained in the fuel dispensing apparatus is jet fuel.

9. The method of claim 2 wherein the indication comprises a flashing light.

10. The method of claim 9 wherein the flashing light is red in color.

11. The method of claim 1 wherein the wireless transmission comprises radio frequency.

12. The method of claim 11 wherein the radio frequency comprises Bluetooth very short range radio frequency.

13. The method of claim 1 wherein the wireless transmission comprises infrared.

14. The method of claim 1 wherein the wireless transmission comprises magnetic energy.

15. The method of claim 1 wherein said first and second signals comprise data representing said first and second fuel types, said data stored in radio frequency identification (“RFID”) tags.

16. The method of claim 15 wherein at least one RFID tag is active.

17. The method of claim 16 wherein at least one RFID tag incorporates a proximity detector.

18. The method of claim 16 wherein at least one RFID tag communicates with a plurality of sensors that are capable of detecting the type of fuel.

19. The method of claim 15 wherein at least one RFID tag is passive.

20. The method of claim 1 wherein the receiver comprises at least one RFID interrogator.

21. The method of claim 20 wherein the RFID interrogator is connected to at least one server.

22. The method of claim 20 wherein the RFID interrogator is associated with the fuel dispensing apparatus.

23. The method of claim 20 wherein the RFID interrogator is associated with the fuel storage apparatus.

24. The method of claim 20 wherein the RFID interrogator is a stand-alone system.

25. The method of claim 20 wherein the RFID interrogator displays the type of fuel required to be introduced into the fuel storage apparatus.

26. The method of claim 20 wherein the RFID interrogator displays whether an additive is required.

27. The method of claim 26 wherein the additive is an anti-icing additive.

28. A system for preventing introduction of an incorrect fuel type into an engine, comprising:
(a) a first identification device associated with a fuel storage apparatus, said first identification device for wirelessly transmitting a first signal corresponding to a first fuel type designated for storage in said fuel storage apparatus;
(b) a second identification device associated with a fuel dispensing apparatus, said second identification device for wirelessly transmitting a second signal corresponding to a second fuel type contained in said fuel dispensing apparatus;
(c) a receiver for receiving signals from said first and second identification devices, said receiver capable of determining whether said first and second fuels are the same or different based on said first and second signals.

29. The system of claim 28 further comprising a device for indicating when said first and second fuels are different.

30. The system of claim 28 further comprising a device for activating said fuel dispensing apparatus when said first fuel type is the same as said second fuel type.

31. The system of claim 28 further comprising a sensor capable of identifying more than one type of fuel.

32. The system of claim 28 wherein at least one of said first and second identification devices is a radio frequency device.

33. The system of claim 28 wherein said receiver is a radio frequency receiver.

34. The system of claim 28 wherein at least one of said first and second identification devices is an infrared device.

35. The system of claim 28 wherein said receiver is an infrared receiver.

36. The system of claim 28 wherein at least one of said first and second identification devices comprises magnetic energy.

37. The system of claim 28 wherein said receiver comprises magnetic energy.
